(19) United States
(12) Patent Application Publication
(10) Pub. No.: US 2004/0090992 A1
(43) Pub. Date: May 13, 2004

(54) Simultaneous voice and data service in mobile communication system

(75) Inventor: Sang Ho Lee, Anyang-si (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/693,916

(22) Filed: Oct. 28, 2003

(30) Foreign Application Priority Data
Oct. 29, 2002 (KR) 10-2002-0066110

(51) Int. Cl. H04L 12/56

(52) U.S. Cl. 370/493; 370/401

(57) ABSTRACT

A method and apparatus for simultaneous voice and data (SVD) service in mobile communication system are disclosed. SVD service can be provided by designating a new voice RLP frame type and adding the new voice RLP frame type in the RLP frame transmittal standard for packet data in CDMA mobile communication system. Further, by designating the new SVD service option or additional signaling message exchange, the signaling procedures or multiplexing and de-multiplexing procedures used for SVD service can be simplified. Thus, mobile terminals and base stations, which could not provide SVD service, can be enabled to provide SVD service by performing SVD call processing between mobile terminals and base stations with only one service option.

### BACKGROUND OF THE INVENTION

1. Field of the Invention

The present invention relates to a method for simultaneous voice and data (SVD) service in mobile communication system.

2. Background of the Related Art

Generally, mobile communication systems based on code division multiple access (CDMA) are classified into synchronous systems whose base stations, which use global positioning system (GPS), and mobile terminals operate with equal time basis and asynchronous systems whose base stations do not use GPS. Services in such CDMA mobile communication systems can be classified into voice communication services, short message services that uses signaling and wireless data services using packet data.

The synchronous CDMA mobile communication system can be classified into ‘cdma one’ and ‘cdma 2000.’ The first ‘cdma one’, is an overall system including IS-95, a second generation radio section protocol, and the second, ‘cdma 2000’, is an overall system based on IS-2000, a third generation radio section protocol.

In a CDMA mobile communication system based on ‘IS-2000’, in order to support SVD services specified in the IS-2000 standard, performance of mobile terminals and base stations should be compliant with the IS-2000 Release A standard. However, mobile terminals and base stations not compliant with the IS-2000 Release A standard do not provide SVD service.

In other words, in order to provide SVD service in the CDMA mobile communication system, a signaling procedure over IS-2000 Release A is needed. Further, a procedure for multiplexing two kinds of traffic into a primary traffic and a secondary traffic or for de-multiplexing traffics, after processing each service negotiation with a separate service option for voice and packet data, is needed.

In addition, in order to provide one more service when only one service between voice and packet data service is provided for during the initial call setup procedure, a SVD service could be provided, if an extra service negotiation procedure is processed. Signaling procedures between mobile terminals and base stations for providing SVD service may perform procedures illustrated in FIGS. 1A and 1B, as specified in 3GPP2 A.S0001-A. In order to add one more service option while any one service of voice and packet data service is provided, IS-2000 Release A additionally designates various service request messages. For example, IS-2000 Release A provides a call assignment message (CLAM), a service request message (SRQM), a service response message (SRPM), a service connect message (SCM), an universal handoff direction message (UHDM), a general handoff direction message (GHDM), an enhanced origination message (EORM), an extended alert with information message (EAWIM), a resource release request message (RRRM), and the like.

In order to transmit voice and packet data simultaneously after a signaling procedure for providing SVD service is performed (e.g. illustrated in FIGS. 1A and 1B), multiplexing and de-multiplexing the voice/data traffic should be performed. Functions for assembling voice and packet data into one traffic and for fragmenting voice and packet data from one traffic are performed by a multiplexing sub-layer located in a medium access control (MAC) sub-layer of the service interface structure illustrated in FIG. 2.

In other words, the multiplexing sub-layer designates bit combinations of voice and packet data according to a multiplexing type decided during service negotiation procedures between mobile terminals and base stations. Types of traffic whose combination is possible are classified according to a first service option and a second service option, between voice and packet data included in a data frame for SVD service, during the service negotiation procedure. into a primary traffic, a secondary traffic and a signaling traffic. These are designated

In more detail, the related art SVD service negotiation procedure in a CDMA mobile communication system designates each service option for voice and packet data service and multiplexes each data with standard transmission speed by classifying the traffic into a first traffic and a second traffic. Because only one service option can be supported when doing service negotiation during the initial call setup procedure, a first traffic is designated. A first traffic and second traffic are designated when a second service negotiation for SVD service is performed.

The multiplexing sub-layer multiplexes the voice traffic, packet data traffic and signaling traffic into one data frame (MuxPDU). The multiplexed data frame structure is multiplexed into two types, as illustrated in FIGS. 3 and 4, depending on how each traffic is assembled in the physical layer. FIG. 3 illustrates MuxPDU Type 1, which has a ‘Rate_Set 1’ type of 9.6 Kbps. FIG. 4 illustrates MuxPDU Type 2, which has a ‘Rate_Set 2’ type of 14.4 Kbps.

There are problems in providing SVD service in the related art CDMA mobile communication system in that mobile terminals and base stations should satisfy at least IS-2000 Release A standard enabling SVD service. The procedure for SVD service is complicated because the service negotiation procedure for additional service is similar to the service negotiation procedure performed during the initial call setup procedure. The additional service negotiation procedure should be performed after call setup is carried out for performing service negotiation for only one service (e.g. voice and packet data service) during the initial call setup procedure.

Further, there is another problem in the related art systems for providing SVD service in that it takes a long time until all service negotiation for voice service and packet data service are completed, when voice service and packet data service are simultaneously requested. On the other hand, it is not problematic to request a voice originating service or voice terminating service for performing call setup procedure for SVD service when a mobile terminal receives packet data service.

The above references are incorporated by reference herein where appropriate for appropriate teachings of additional or alternative details, features and/or technical background.

### SUMMARY OF THE INVENTION

An object of embodiments of the invention is to solve at least the above problems and/or disadvantages and to provide at least the advantages described hereinafter.

An object of embodiments of the present invention is to provide SVD service for transmitting and receiving voice and packet data together.

An object of embodiments of the present invention is to designate a new voice RLP frame type.

An object of embodiments of the present invention is to add the new voice RLP frame type in the RLP frames, transmittal standard for packet data in CDMA mobile communication system.

An object of embodiments of the present invention is, to perform SVD call processing between mobile terminals and base stations with one service option through designating a new SVD service option or additional signaling message exchange.

An object of embodiments of the present invention is to make various signaling procedures or multiplexing and de-multiplexing procedures needed for SVD service simple

An object of embodiments of the present invention is to enable mobile terminals and base stations, which could not provide SVD service, to provide SVD service, by performing SVD call processing between mobile terminals and base stations with only one service option.

In order to achieve the above objects, in whole or in parts, there is provided a method for SVD service in mobile communication system, including: performing SVD call processing that supports SVD service between mobile terminals and base stations by using SVD service option; and providing SVD service by transmitting and receiving voice and packet data by means of RLP frame after service negotiation using the SVD service option is completed.

Preferably, said performing SVD call processing by using SVD service option designates and uses service reference ID for new SVD service option which is different from pre-designated voice service option or packet data service option.

Further, in order to achieve the above objects, in whole or in parts, there is provided another method for SVD service in mobile communication service including: in a case where SVD service is requested while packet call setup between a mobile terminal and a base station is completed, performing SVD call processing that supports SVD service through SVD request signaling message exchange; and providing SVD service by transmitting and receiving voice and packet data by means of RLP frame after service negotiation is completed through the SVD request signaling message exchange.

Preferably, the method for SVD service in mobile communication service further includes: implementing in MAC sub-layer voice RLP module which assembles voice frame into RLP frame and fragments the voice frame from the RLP frame, in order to transmit and receive the voice and packet data by means of RLP frame.

Preferably, the method for SVD service in mobile communication service designates voice RLP frame type using bits combination not designated in frame type field of data RLP frame, in order to transmit and receive the voice and packet data by means of RLP frame.

Preferably, the method for SVD service in mobile communication service designates voice RLP frame type using bits combination not designated in control field of data RLP frame, in order to transmit and receive the voice and packet data by RLP frame.

Preferably, said providing SVD service by transmitting and receiving voice and packet data by means of RLP frame includes: transforming packet data frame into data RLP frame or transforming voice frame into voice RLP frame, by using frame type field or control field not used in the data RLP frame.

Preferably, if the voice frame is full rate voice frame, the voice frame is transformed into voice RLP frame by using bits combination not used in frame type field of data RLP frame and the voice RLP frame transformed from the full rate voice frame includes 168 bits voice frame information, 3 bits frame type information indicating of which frame type is voice RLP frame type.

Preferably, if the voice frame is half rate voice frame or voice frame under ½ rate, the voice frame is transformed into voice RLP frame by using bits combination not used in control field of data RLP frame. The data RLP frame used for transforming the half rate voice frame or voice frame under ½ rate into voice RLP frame is one of control frame, fragmented/assembled data frame, fill frame and idle frame.

Preferably, the voice RLP frame transformed from the half rate voice frame or voice frame under ½ rate is half or ½ rate voice RLP frame including 8 bits and 66 bits voice frame information and 6 bits control field information indicating of which frame type is voice RLP frame type.

Preferably, the voice RLP frame transformed from the half rate voice frame or voice frame under ½ rate is quarter or ¼ rate voice RLP frame including 8 bits and 26 bits voice frame information and 6 bits control field information indicating of which frame type is voice RLP frame type.

The voice RLP frame transformed from the half rate voice frame or voice frame under ½ rate is eighth or ⅛ rate voice RLP frame including 8 bits and 6 bits voice frame information and 6 bits control field information indicating of which frame type is voice RLP frame type.

Additionally, embodiments of the present invention can include a mobile communication apparatus comprising: a service interface having a voice radio link protocol (RLP) module and a data RLP module at a MAC sub-layer, configured to transmit and receive voice and packet data together by using a RLP frame.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIGS. 1A and 1B illustrate additional signaling procedures of the related art between a mobile terminal and a base station, for providing SVD service in CDMA mobile communication system.

FIG. 2 illustrates service interface structure of the related art CDMA mobile communication system.

FIG. 3 illustrates structure of MuxPDU Type 1 designated at multiplexing sub-layer illustrated in FIG. 2.

FIG. 4 illustrates structure of MuxPDU Type 2 designated at multiplexing sub-layer illustrated in FIG. 2.

FIG. 5 illustrates a structure of a service interface of CDMA mobile communication system according to an embodiment of the present invention.

FIGS. 6A, 6B, 6C and 6D illustrate structures of RLP frame type processed with full rate for explaining a method of transforming full rate voice frame into voice RLP frame according to an embodiment of the present invention.

FIGS. 7, 8, 9A, 9B, 10A and 10B illustrate structures of various RLP frame type processed with half rate or rate under ½ for explaining a method of transforming full rate voice frame into voice RLP frame according to an embodiment of the present invention.

FIGS. 11A, 11B, 11C and 11D illustrate frame structures designated as voice RLP frames.

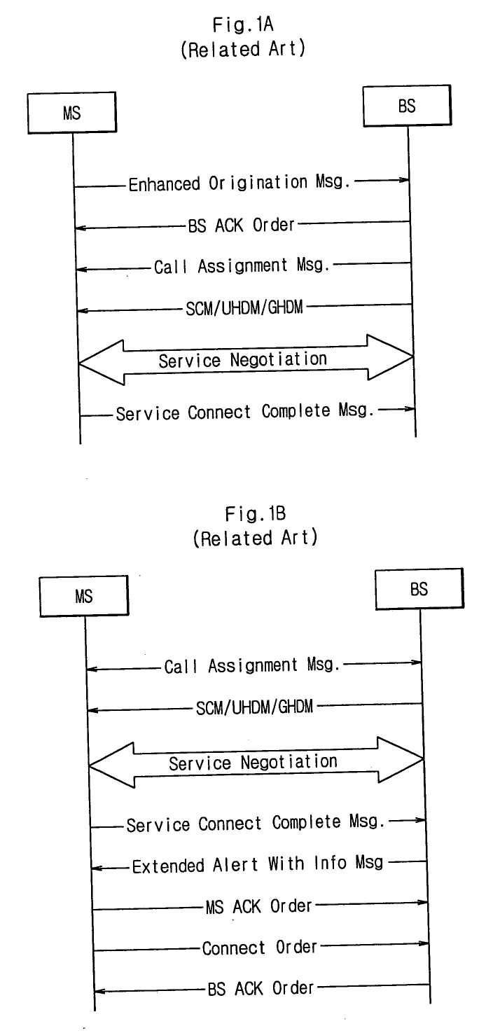

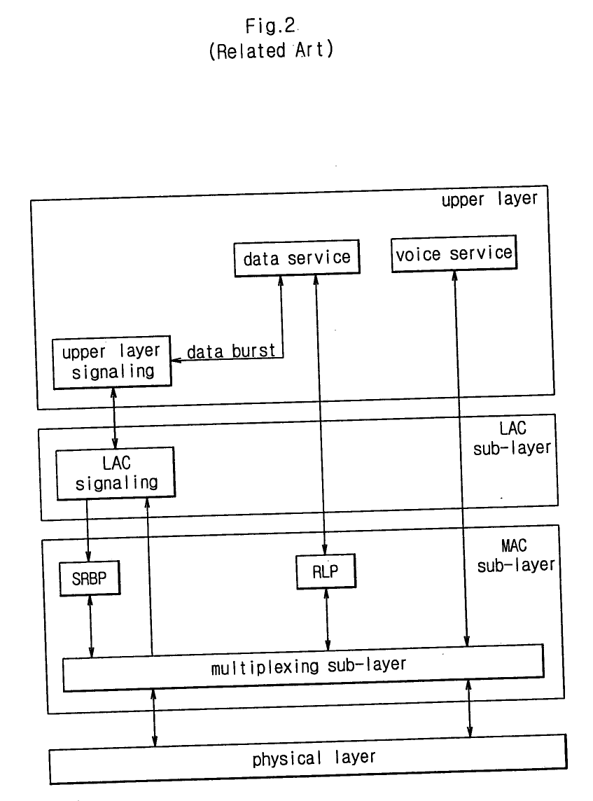

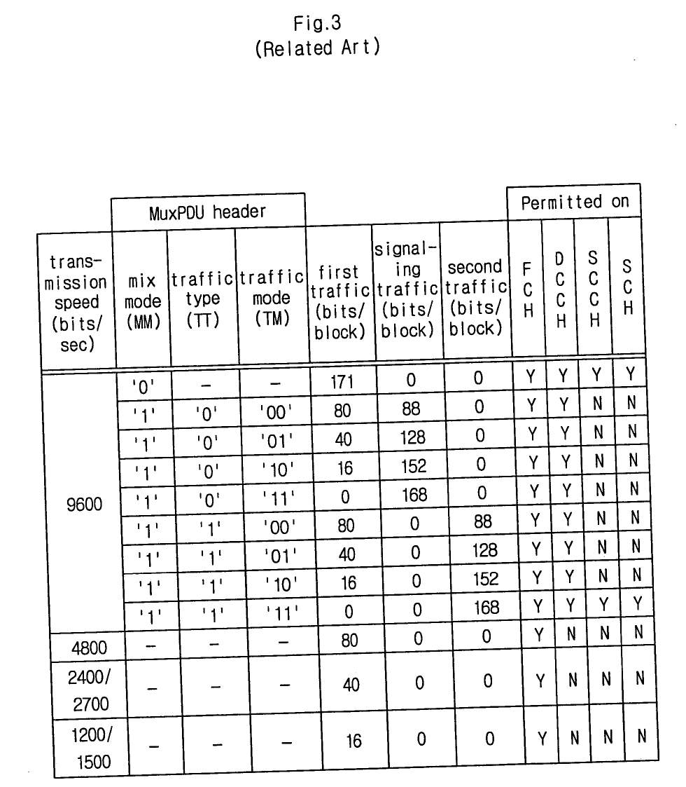

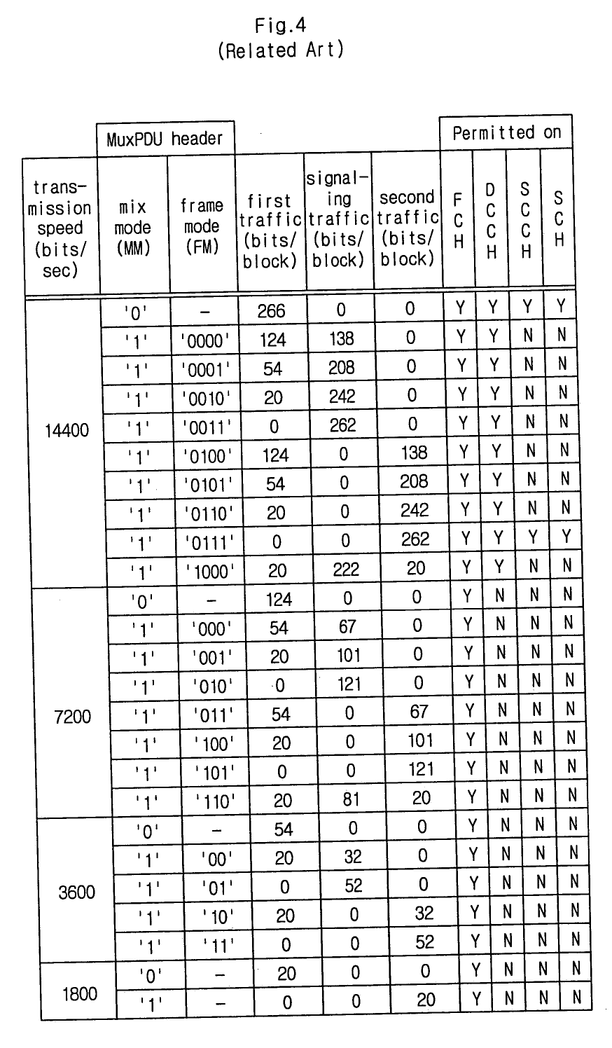

### DETAILED DESCRIPTION OF PREFERRED EMBODIMENTS

By adding a new voice RLP frame type to an RLP frame for transmitting standard packet data used in packet data service options in CDMA mobile communication systems according to an embodiment of the present invention, mobile terminals and base stations which could not support SVD service may provide SVD service by performing only one service option for transmitting and receiving voice and packet data together. Further, mobile terminals and base stations supporting SVD service, may provide SVD service by performing only one service option for transmitting and receiving voice and packet data together.

Call processing procedures between a mobile terminal and a base station for providing the SVD service may use the same method as the general call processing procedure for packet data. The call processing procedures may perform SVD call processing by defining a new SVD service option or through additional signaling message exchange.

The method of performing SVD call processing by designating a new SVD service option designates a service reference ID for the new SVD service option instead of the voice service option already used or packet data service option already used. The new SVD service option provides SVD service by using voice and packet data together by means of a RLP frame after service negotiation is completed with the SVD service option.

On the other hand, the method of performing SVD call processing through additional signaling message exchange performs additional signaling message exchange after the packet data call setup is completed with the packet data service option. The method of performing SVD call processing through additional signaling message exchange provides SVD service by the additional signaling message exchange by transmitting and receiving voice and packet data together using the RLP frame.

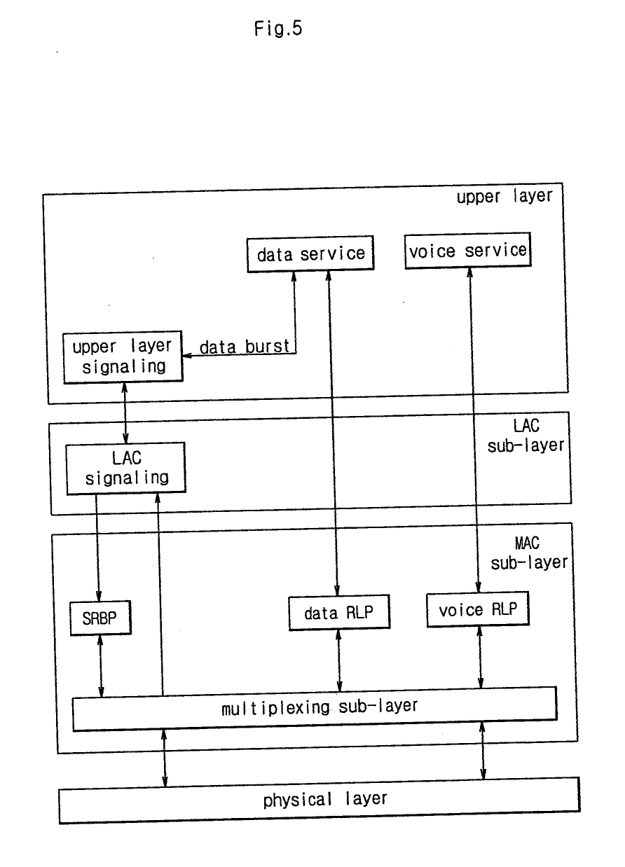

As illustrated in FIG. 5, a service interface between a mobile terminal and a base station can have a voice RLP module at the MAC sub-layer in addition to a data RLP module, in order to transmit and receive voice and packet data together by using one RLP frame. The data RLP module performs fragmentation of packet data frame in an upper layer from the RLP frame or assembly of packet data frame in upper layer into the RLP frame. The voice RLP module performs fragmentation of a voice frame in an upper layer from the RLP frame or assembly of the voice frame in an upper layer into the RLP frame.

The data RLP module and voice RLP module are modules that perform processing using a negative acknowledge (NAK)-based protocol. A transmitting device transmits data by providing sequence numbers to the data. A receiving device processes the data by receiving the data in order of the sequence numbers. If an error is detected in the sequence of the received data, the receiving device requests retransmission of corresponding data by transmitting NAK message to the transmitting device. RLP frames can be transmitted and received through the fundamental channel (FCH), which is a basic channel. The RLP frames include control frames (e.g. SYNC, SYNC_ACK, ACK and NAK control frame) for synchronizing the transmitting device and the receiving device or requesting retransmission and data frames fragmented or assembled according to each RLP format (e.g. RLP format A, RLP format B).

The RLP modules classify RLP frames combined into one traffic in the multiplexing sub-layer into data RLP frames and voice RLP frames. The data RLP frame can have various transmission speeds and lengths. In contrast, the voice RLP frames are classified into full rate voice RLP frames, half rate or (½) rate voice RLP frames, quarter rate or (¼) rate voice RLP frame and eighth rate or (⅛) rate voice RLP frames.

Accordingly, an embodiment of the present invention uses the frame type field not used in existing data RLP frame as a voice RLP frame type. The voice RLP frame type is designated using frame types not used in existing data RLP frames, in order to differentiate the above-described four voice RLP frames from data RLP frames. In order to transform a voice frame received from an upper layer into a voice RLP frame, 2 or 3 bits of the frame type field not used in data RLP frame or 1, 4 or 6 bits of the control field are additionally defined and used.

Further, methods of transforming a voice frame into a voice RLP frame can be classified into two general methods. The two general methods are a method of transforming full rate voice frame into voice RLP frame and a method of transforming half rate voice frame or voice frame under ½ rate into a voice RLP frame.

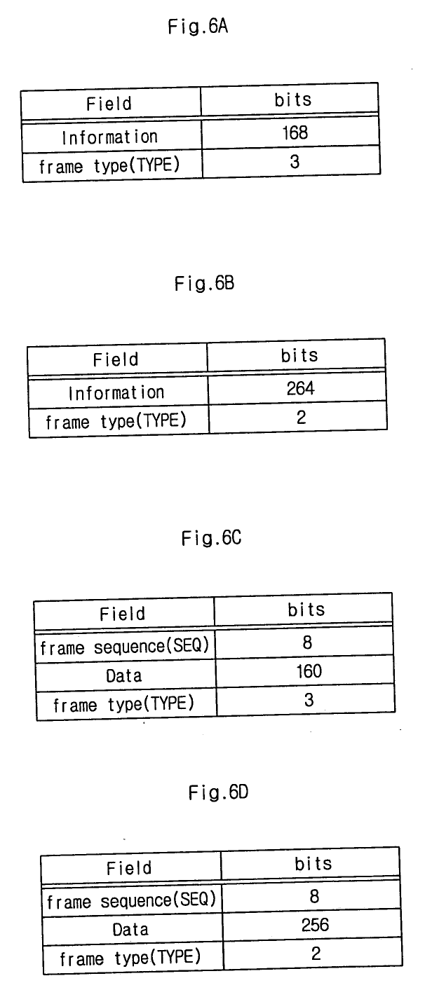

First, the method of transforming a full rate voice frame into a voice RLP frame will be explained with reference to FIGS. 6A, 6B, 6C and 6D. Types of RLP frames processed with full rate are RLP format A illustrated in FIGS. 6A and 6B and RLP format B illustrated in FIGS. 6C and 6D. At this time, a factor distinguishing a full rate RLP frame type is frame type (TYPE) field and the frame type field is 2 bits or 3 bits.

In other words, when RLP format A is used, the frame type is designated as ‘001’ in Rate_Set 1 and designated as ‘01’ in Rate_Set 2. When RLP format B is used, the frame type of a new frame is designated as ‘010’ in Rate_Set 1 and designated as ‘10’ in Rate_Set 2. Further, a frame type of a retransmission frame is designated as ‘011’ in Rate_Set 1 and designated as ‘11’ in Rate_Set 2 when RLP format B is used.

Because a full rate RLP frame already uses ‘001’, ‘010’ and ‘011’ in Rate_Set 1 and uses ‘01’, ‘10’ and ‘11’ in Rate_Set 2, an embodiment of the present invention may easily distinguish data RLP frames or voice RLP frames in the de-multiplexed traffic by designating full rate voice RLP frame type using any one value of the unused bit combinations (e.g., ‘100’, ‘101’, ‘110’ and ‘111’ in Rate_Set 1 and ‘00’ in Rate_Set 2) of the frame type field in order to use a voice RLP frame by transforming a full rate voice frame into a voice RLP frame. The bit combination ‘000’ is not used as voice RLP frame type even though ‘000’ in Rate_Set 1 is not used because it is reserved to prevent confusing ‘000’ with a bit combination for padding in other RLP formats.

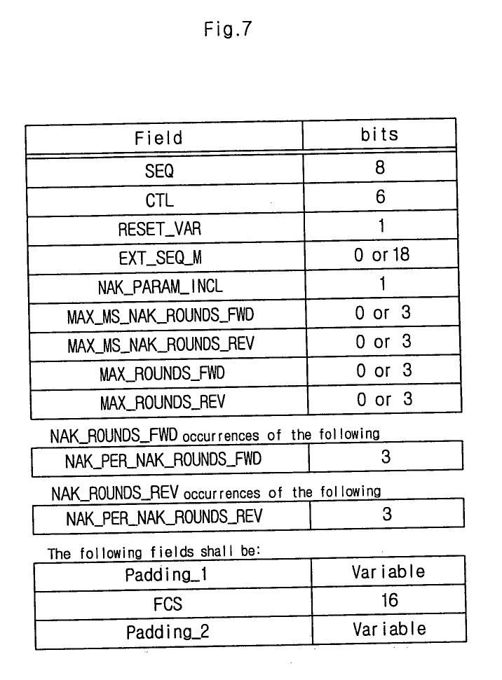

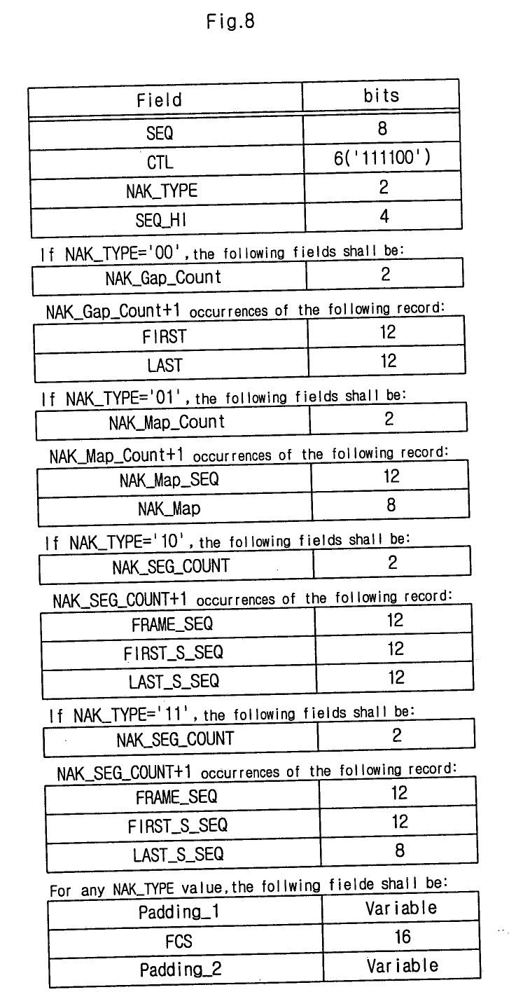

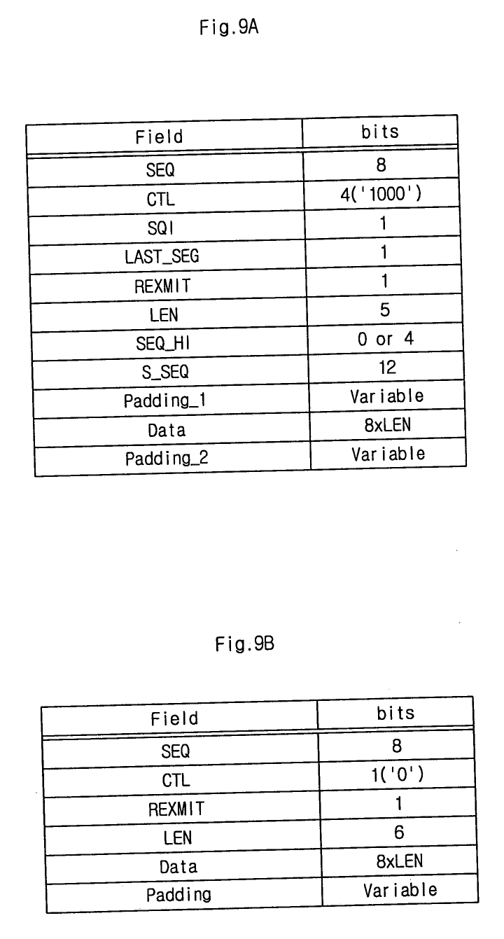

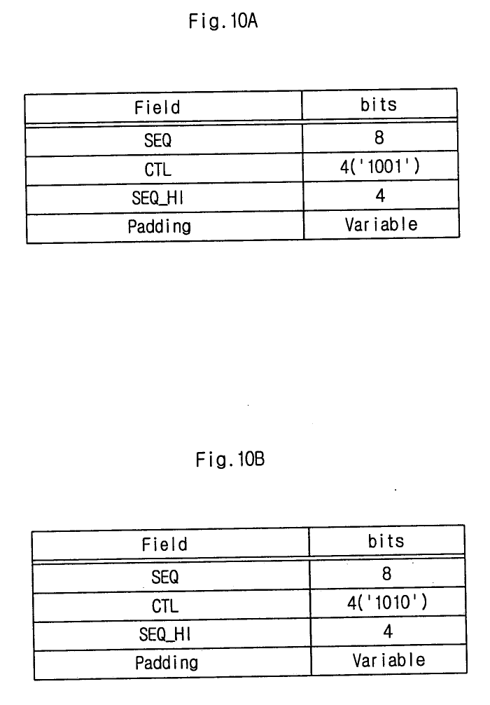

Second, the method of transforming half rate voice frame or voice frame under ½ rate into voice RLP frame will be explained with reference to FIGS. 7 to 10B. RLP frames processed with a half rate or under ½ rate include control frames as illustrated in FIGS. 7 and 8, fragmented/assembled data frames as illustrated in FIGS. 9A and 9B and fill frames and idle frames, as illustrated in FIGS. 10A and 10B. A factor for distinguishing half rate RLP frame types or RLP frame types under ½ rate is a control (CTL) field and the control field may use 6 bits, 4 bits or 1 bit.

A control field of a control frame may be to 6 bits as illustrated in FIGS. 7 and 8. FIG. 7 illustrates that a bit combination of ‘110110’ is designated as synchronous (SYNC) control frame. A bit combination of ‘111010’ is designated as positive acknowledge (ACK) control frame and a bit combination of ‘111110’ is designated as synchronous (SYNC)/positive acknowledge (ACK) control frame, as illustrated in FIG. 7. FIG. 8 illustrates that a bit combination of ‘111100’ is designated as negative acknowledge (NAK) control frame.

The control field of fragmented/assembled data frame amounts to 4 bits or 1 bit as illustrated in FIGS. 9A and 9B. FIG. 9A illustrates that bit combinations of ‘1000xx’ are designated as fragmented data frame and FIG. 9B illustrates that bit combinations of ‘0xxxxx’ are designated as assembled data frame.

FIGS. 10A and 10B illustrate that the fill frame and idle frame may use 4 bits. In the frame structure illustrated in FIG. 10A, bit combinations of ‘1001xx’ are designated as a fill frame. Bit combinations of ‘1010xx’ are designated as idle frame as illustrated in FIG. 10B.

Accordingly, an embodiment of the present invention designates a voice RLP frame type of half rate (½) rate, quarter rate (¼) rate, or eighth (⅛) rate using the following bit combinations of the control field (‘1011xx’, ‘110001’, ‘110010’, ‘110011’, ‘110100’, ‘110101’, ‘110111’, ‘111000’, ‘111001’, ‘111011’, ‘111100’, ‘111101’, ‘111111’). These bit combinations are not currently used in data RLP frames, and are used to transform voice frames processed with a half rate or rate under ½ into a voice RLP frame and use the voice RLP frame.

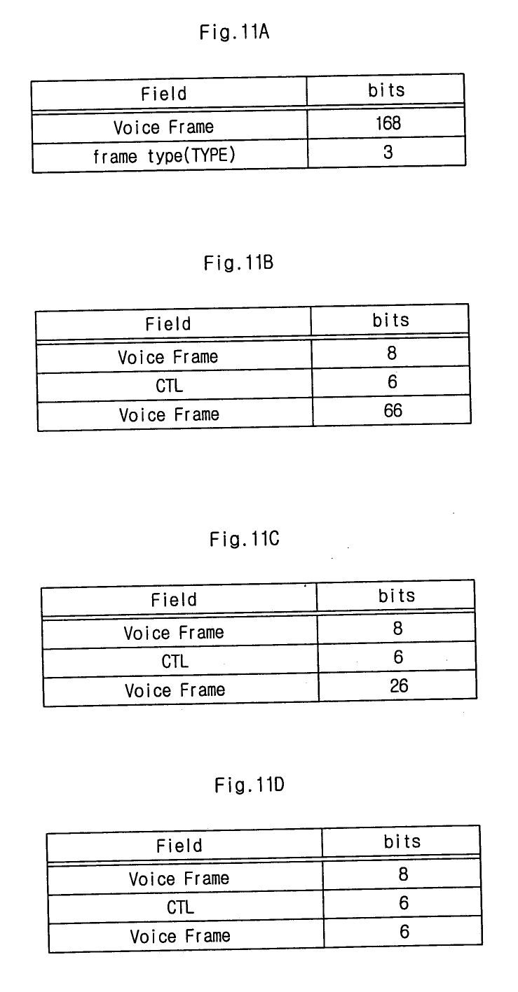

FIGS. 11A, 11B, 11C and 11D illustrate frame structures for transforming voice frames into voice RLP frames using bit combinations not currently used in the frame type field or the control field of a data RLP frame. FIG. 11A illustrates a full rate voice RLP frame. FIG. 11B illustrates a half rate (½) rate voice RLP frame. FIG. 11C illustrates quarter rate (¼) rate voice RLP frame and FIG. 11D illustrates eighth rate (⅛) rate voice RLP frame.

In CDMA mobile communication system according to embodiments of the present invention, SVD service is provided by way of transmitting and receiving voice and packet data together by using only one service option regardless of whether or not a mobile terminal and a base station support SVD service. SVD call processing may be performed by designating a new SVD service option or by additional signaling message exchange.

After a call setup is completed according to the SVD call processing, a data RLP frame is transmitted and received according to a conventional method. In contrast, when using a voice RLP frame, full rate voice RLP frame is transmitted and received using certain bit combinations not currently used in the frame type field of existing data RLP frames. Likewise, half rate voice RLP frame or voice RLP frame under ½ rate is transmitted and received using certain bit combinations not currently used in the control field of existing data RLP frames.

As noted above, embodiments of the present invention may provide SVD service may transmit and receive voice and packet data together by designating a new voice RLP frame type and by adding the new voice RLP frame type to the transmittal standard of packet data.

Embodiments of the present invention may simplify various signaling process as used for SVD service or multiplexing/de-multiplexing. Further, embodiments of the present invention may provide SVD service through a mobile terminal and a base station which previously could not support SVD service, by performing SVD call processing between a mobile terminal and a base station using only one service option. This is accomplished by designating a new SVD service option or an additional signaling message exchange and by providing SVD service by transmitting and receiving voice and packet data together by means of RLP frame.

Accordingly, embodiments of the present invention provide methods and apparatuses for simultaneous voice and data (SVD) service in mobile communication system. Further, the SVD service may simultaneously provide voice service and packet data service by providing the services as one service option in code division multiple access (CDMA) mobile communication systems based on interim standard (IS)-2000.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for simultaneous voice and data (SVD) service in mobile communication system, comprising:
performing SVD call processing that supports SVD service between mobile terminals and base stations by using a SVD service option; and
providing SVD service by at least one of transmitting and receiving voice and packet data using a radio link protocol (RLP) frame after service negotiation using the SVD service option is completed.

2. The method of claim 1, wherein said performing SVD call processing by using SVD service option designates and uses a service reference ID for a new SVD service option which is different from a pre-designated voice service option or packet data service option.

3. The method of claim 1, further comprising:
implementing in a media access control (MAC) sub-layer voice RLP module, which assembles a voice frame into RLP frame and fragments, the voice frame from the RLP frame, in order to transmit and receive the voice and packet data by means of RLP frame.

4. The method of claim 1, further comprising:
designating a voice RLP frame type using bit combinations not designated in a frame type field of a data RLP frame, in order to transmit and receive the voice and packet data by means of the RLP frame.

5. The method of claim 1, further comprising:
designating a voice RLP frame type using bit combinations not designated in a control field of a data RLP frame, in order to transmit and receive the voice and packet data by means of the RLP frame.

6. The method of claim 1, wherein said providing SVD service by transmitting and receiving voice and packet data by means of RLP frame comprises:
at least one of transforming a packet data frame into a data RLP frame and transforming a voice frame into voice RLP frame, by using a frame type field or a control field not used in the data RLP frame.

7. The method of claim 6, wherein the voice frame is transformed into the voice RLP frame by using bit combinations not used in the frame type field of the data RLP frame, if the voice frame is a full rate voice frame.

8. The method of claim 7, wherein the voice RLP frame transformed from the fill rate voice frame comprises 168 bits of voice frame information, and 3 bits of frame type information indicating which frame type is the voice RLP frame type.

9. The method of claim 6, wherein the voice frame is transformed into the voice RLP frame by using bit combinations not used in the control field of the data RLP frame, if the voice frame is a half rate voice frame or a voice frame under ½ rate.

10. The method of claim 9, wherein the data RLP frame used for transforming the half rate voice frame or voice frame under ½ rate into the voice RLP frame is one of control frame, fragmented/assembled data frame, fill frame and idle frame.

11. The method of claim 9, wherein the voice RLP frame transformed from the half rate voice frame or voice frame under ½ rate is a half or ½ rate voice RLP frame, comprising 8 bits and 66 bits of voice frame information and 6 bits of control field information indicating which frame type is a voice RLP frame type.

12. The method of claim 9, wherein the voice RLP frame transformed from the half rate voice frame or voice frame under ½ rate is a quarter or ¼ rate voice RLP frame comprising 8 bits and 26 bits of voice frame information and 6 bits of control field information indicating which frame type is a voice RLP frame type.

13. The method of claim 9, wherein the voice RLP frame transformed from the half rate voice frame or voice frame under ½ rate is an eighth or ⅛ rate voice RLP frame comprising 8 bits and 6 bits of voice frame information and 6 bits of control field information indicating which frame type is a voice RLP frame type.

14. A method for simultaneous voice and data (SVD) service in mobile communication system, comprising:
performing SVD call processing that supports SVD service through SVD request signaling message exchange, when SVD service is requested while packet call setup between a mobile terminal and a base station is completed; and
providing SVD service by at least one of transmitting and receiving voice and packet data using a radio link protocol (RLP) frame after service negotiation is completed through the SVD request signaling message exchange.

15. The method of claim 14, further comprising:
implementing in a media access control (MAC) sub-layer voice RLP module, which assembles voice frame into RLP frame and fragments, the voice frame from the RLP frame, in order to transmit and receive the voice and packet data by means of the RLP frame.

16. The method of claim 14, further comprising:
designating voice RLP frame type using bit combinations not designated in a frame type field of a data RLP frame, in order to transmit and receive the voice and packet data by means of the RLP frame.

17. The method of claim 14, further comprising:
designating a voice RLP frame type using bit combinations not designated in a control field of a data RLP frame, in order to transmit and receive the voice and packet data by means of the RLP frame.

18. The method of claim 14, wherein said providing SVD service by transmitting and receiving voice and packet data by means of RLP frame comprises:
at least one of transforming a packet data frame into a data RLP frame and transforming a voice frame into a voice RLP frame, by using a frame type field or a control field not used in the data RLP frame.

19. The method of claim 18, wherein the voice frame is transformed into the voice RLP frame by using bit combinations not used in the frame type field of the data RLP frame, if the voice frame is full rate voice frame.

20. The method of claim 19, wherein the voice RLP frame transformed from the full rate voice frame comprises 168 bits of voice frame information, and 3 bits of frame type information indicating which frame type is the voice RLP frame type.

21. The method of claim 18, wherein the voice frame is transformed into the voice RLP frame by using bit combinations not used in the control field of the data RLP frame, if the voice frame is a half rate voice frame or a voice frame under ½ rate.

22. The method of claim 21, wherein the data RLP frame used for transforming the half rate voice frame or voice frame under ½ rate into the voice RLP frame is one of control frame, fragmented/assembled data frame, fill frame and idle frame.

23. The method of claim 21, wherein the voice RLP frame transformed from the half rate voice frame or voice frame under ½ rate is a half or ½ rate voice RLP frame comprising 8 bits and 66 bits of voice frame information and 6 bits of control field information indicating which frame type is a voice RLP frame type.

24. The method of claim 21, wherein the voice RLP frame transformed from the half rate voice frame or voice frame under ½ rate is a quarter or ¼ rate voice RLP frame comprising 8 bits and 26 bits of voice frame information and 6 bits of control field information indicating which frame type is a voice RLP frame type.

25. The method of claim 21, wherein the voice RLP frame transformed from the half rate voice frame or voice frame under ½ rate is an eighth or ⅛ rate voice RLP frame comprising 8 bits and 6 bits of voice frame information and 6 bits of control field information indicating which frame type is a voice RLP frame type.

26. A mobile communication apparatus comprising:
a service interface having a voice radio link protocol (RLP) module and a data RLP module at a MAC sub-layer, configured to transmit and/or receive voice and packet data together by using a RLP frame.

27. The apparatus of claim 26, wherein the data RLP module is configured to perform at least one of fragmentation of a packet data frame in an upper layer and assembly of a packet data frame in the upper layer into the RLP frame.

28. The apparatus of claim 26, the voice RLP module is configured to perform at least one of fragmentation of a voice frame in an upper layer and assembly of the voice frame in an upper layer into the RLP frame.

29. The apparatus of claim 26, wherein voice RLP frames are classified into full rate voice RLP frames, half rate (½) rate voice RLP frames, quarter rate (¼) voice RLP frame and eighth (⅛) rate voice RLP frames.

30. The apparatus of claim 26, wherein the apparatus is at least one mobile terminal and a base station.

31. The apparatus of claim 26, wherein the apparatus is mobile communication system comprising at least one mobile terminal and at least one base station.
